(19) United States
(12) Patent Application Publication
(10) Pub. No.: US 2026/0371373 A1
(43) Pub. Date: Nov. 19, 2026

(54) RESOURCES FOR BROADCAST OF UNMANNED AERIAL VEHICLE IDENTIFICATION

(71) Applicant: Telefonaktiebolaget LM Ericsson (publ), Stockholm (SE)

(72) Inventors: Mattias BERGSTRÖM, Sollentuna (SE); Antonio ORSINO, Kirkkonummi (FI); Hieu DO, Jarfalla (SE); Helka-Liina MÄÄTTÄNEN, Espoo (FI); Nithin SRINIVASAN, Koln (DE)

(21) Appl. No.: 19/102,157

(22) PCT Filed: Aug. 9, 2023
(86) PCT No.: PCT/EP2023/071999

§ 371 Date: Feb. 7, 2025

Related U.S. Application Data
(60) Provisional application No. 63/396,414, filed on Aug. 9, 2022.
(60) Provisional application No. 63/501,460, filed on May 11, 2023.

(51) Int. Cl. H04W 72/40; H04W 8/18; H04W 28/02; H04W 72/02; H04W 76/20; H04W 84/06

(52) U.S. Cl. CPC H04W 72/40; H04W 8/183; H04W 28/0268; H04W 72/02; H04W 76/20; H04W 84/06

(57) ABSTRACT

Techniques, apparatuses, and systems for communicating identification information for unmanned aerial vehicles, UAVs. An example method, in a wireless device in, on, or forming part of a UAV, comprises determining to transmit UAV identification, ID, information; determining one or more resources for transmitting the UAV ID information, the determined one or more resources being specifically designated for use in transmitting UAV ID information, to the exclusion of transmitting non-UAV-related information; and transmitting the UAV ID information using the determined one or more resources.

### TECHNICAL FIELD

The present disclosure is generally related to wireless communications and is more particularly related to the wireless communication of identification information for unmanned aerial vehicles.

### BACKGROUND

### UAV Communications in 3GPP

The world is witnessing a widespread and increasing use of drones, or, more technically, Unmanned Aerial Vehicles (UAV), in many segments of the economy and in our daily life. There are numerous use cases for UAVs in industry, goods transportation and delivery, surveillance, media production, etc.

Traditionally, the UAVs can only be flown by a controller within a visual line of sight (VLoS). Realizing the great potential of connecting drones beyond visual line of sight (BVLoS), via a cellular network, members of the 3^{rd}-Generation Partnership Project (3GPP) have specified multiple features in LTE Rel-15, aiming at improving the efficiency and robustness of terrestrial LTE network for providing aerial connectivity services, particularly for low altitude UAVs. These features target both command-and-control traffic for flying the drone and the data (also known as payload) traffic from the drone to the cellular network. Key features specified include:
Support for subscription-based identification
Height reporting when UAV crosses a height threshold. The report includes height, location (3D), horizontal and vertical speed.
Reference Signal Received Power (RSRP) or Reference Signal Received Quality (RSRQ) reporting per event of N cells' signal power above a threshold. The report includes RSRP/RSRQ/location (3D).
UE-specific uplink (UL) power control.
Flight path information provided from UE to eNB. This includes network polling and list of waypoints (3D location), time stamp if available.

These features were introduced to target special needs when serving the UAVs by LTE network, e.g., the need for flying mode detection, interference detection, and interference mitigation. The first important issue was flying mode detection, which is also related to interference detection, as the interference conditions for flying aerial UEs are different from aerial UE in terrestrial mode. For interference detection, which may also serve as input to flying mode detection, an enhancement to existing events triggering of RSRP/RSRQ/RS-SINR reports was introduced in LTE Rel-15. The UE may be configured to trigger an event such as A3, A4, A5, which all consider neighbor cell measurements. In such event triggers, a measurement report is triggered when multiple cells' measured RSRPs (RSRQs/RS-SINRs) are above a threshold.

Another input to flying mode detection is event-triggered height and location reporting. A new configurable event within Radio Resource Management (RRM) with height threshold is introduced for Rel-15 Aerial UEs. When the UE is configured with an event, a report is triggered when UE's altitude crosses the threshold altitude. In addition to flying mode detection, the exact height information is considered useful as the network may choose to reconfigure, for example, measurement reporting configurations for the UE when it crosses a height threshold. FIG. 1 depicts this situation, showing a network (e.g., the E-UTRAN) reconfiguring an aerial UE based on flying altitude. In this figure, when the UE is below a height of 100 m, the aerial UE is RRC configured with measurement reporting configurations and event-triggered height/location reporting corresponding to a height threshold of 200 m. As the aerial UE crosses a height threshold of 200 m, a report is trigged from the UE to the network. After receiving the report from the aerial UE, the network RRC reconfigures the aerial UE with new measurement reporting configurations.

### Sidelink Communications

3GPP specified the LTE D2D (device-to-device) technology, also known as the sidelink (SL) or the PC5 interface, as part of Release 12 (Rel-12). The target use cases (UC) were the Proximity Services (ProSe) covering both communication and discovery. In Rel-14, the LTE SL was extensively redesigned to support vehicular communications (commonly referred to as V2X) for road-safety applications and some further enhancements were specified during Rel-15. From the point of view of the lowest radio layer (PHY layer), the LTE SL uses broadcast communication, i.e., the transmission from a transmitter UE targets all receiver UEs in its proximity.

In Rel-16, 3GPP introduced the sidelink for the 5G new radio (NR). The driving UCs were advanced V2X UCs (e.g., cooperative driving or sensor sharing) with more stringent requirements than those typically served using the LTE SL. To meet these requirements, the NR SL was designed to support both broadcast, groupcast, and unicast communications at PHY layer. Notably, HARQ feedback was introduced for SL groupcast and unicast. In Rel-17 and Rel-18, NR SL has been evolved to include discontinuous reception (DRX), inter-UE coordination, sidelink in unlicensed spectrum, and so on.

Both LTE SL and NR SL can operate with and without network coverage and with varying degrees of interaction between the UEs (user equipment) and the NW (network), including support for network-less operation.

### Sidelink Communications for UAVs

There is a growing interest in the telecom industry to enhance the 5G NR standards to support UAV communication. This includes serving the UAVs as aerial-UEs via uplink and downlink (i.e., the Uu interface) and supporting direct communication between UAVs (i.e., via the PC5 interface). The latter is considered useful for the collision Detection and Avoidance (D/A) use cases, for example, whereby the UAVs are able to detect the presence of one another and to react to avoid collisions. In fact, 3GPP has taken these demands into account when setting the requirements for remote identification of UAVs in 3GPP TS 22.125 V17.3.0 (March 2021), as can be seen in the following excerpt from that standards document:
5.2.2 Decentralized UAS [Unmanned Aircraft System] traffic management
[R-5.2.2-001] The 3GPP system shall enable a UAV to broadcast the following data for identifying UAV(s) in a short-range area for collision avoidance: e.g.
UAV identities if needed based on different regulation requirements, UAV type, current location and time, flight route information, current speed, operating status.
[R-5.2.2-002] The 3GPP system shall be able to support a UAV to transmit a message via network connection for identifying itself as an UAV to the other UAV(s).
[R-5.2.2-003] The 3GPP system shall enable UAV to preserve the privacy of the owner of the UAV, UAV pilot, and the UAV operator in its broadcast of identity information.
[R-5.2.2-004] The 3GPP system shall enable a UAV to receive local broadcast communication transport service from other UAV in short range.
[R-5.2.2-005]A UAV shall be able to use a direct UAV to UAV local broadcast communication transport service in the coverage or out of coverage of a 3GPP network.
[R-5.2.2-006]A UAV shall be able to use a direct UAV to UAV local broadcast communication transport service when the sending and receiving UAVs are served by the same or different PLMNs.
[R-5.2.2-007] The 3GPP system shall support a direct UAV to UAV local broadcast communication transport service at relative speeds of up to 320 kmph.
[R-5.2.2-008] The 3GPP system shall support a direct UAV to UAV local broadcast communication transport service with variable message payloads of 50-1500 bytes, not including security-related message component(s).
[R-5.2.2-009] The 3GPP system shall support a direct UAV to UAV local broadcast communication transport service which supports a range of up to 600 m.
[R-5.2.2-010] The 3GPP system shall support a direct UAV to UAV local broadcast communication transport service which can transmit messages at a frequency of at least 10 messages per second.
[R-5.2.2-011] The 3GPP system shall support a direct UAV to UAV local broadcast communication transport service which can transmit messages with an end-to-end latency of at most 100 ms.

In summary, it is required that the 3GPP system support the broadcasting of UAV identity and other information related to UAV's speed and route over the PC5 interface for the purpose of collision detection and avoidance. Moreover, the UAV-to-UAV communication over PC5 should be able to support regularly broadcasted messages with certain payload size and latency requirements, both in network coverage and out of network coverage.

In the ongoing Rel-17, 3GPP is working on enhancements to the NR SL. The ambition is not only to improve the capabilities of NR SL for V2X but also to address other UCs such as National Security and Public Safety (NSPS) as well as commercial UCs such as Network Controlled Interactive Services (NCIS). In particular, inter-UE coordination in resource allocation is being specified to improve the reliability of SL communications, whereas SL discontinuous reception (SL-DRX) and partial resource sensing are being specified for power/energy saving purposes.

There are two resource allocation modes in SL. In a first mode, SL transmissions by the UEs are scheduled by a network node (e.g., eNB or gNB), i.e., the network node grants the SL resources to the UEs. This network-scheduled mode is often referred to as Mode 1 in NR SL Rel-16 and as Mode 3 in LTE SL Rel-14. In a second mode, UEs autonomously find resources for their SL transmissions in a set of resources configured by the network or preconfigured, often referred to as SL resource pool, where a resource pool is a set of subframes and resource blocks, e.g., in a particular bandwidth part (BWP). If a UE is in “Out of coverage mode,” the UE uses the preconfigured resources and if the UE is in “in-coverage mode” UE uses network-configured resources, provided to the UE via signaling of a System Information Block (SIB), if the UE is in RRC Idle mode, or via dedicated RRC signaling, if the UE is in the RRC Connected mode. This mode of resource allocation is referred to as Mode 2 in in NR SL Rel-16 and as Mode 4 in LTE SL Rel-14. In the latter mode, each UE typically tries to decode control information sent by the other UEs and measures interference level on different resource units to find the most suitable resources for the UE's transmissions, a process often referred to as resource sensing.

### Sidelink-Based UAV Communications

In Rel-18, 3GPP is working on enhancements to 5G NR standards to support UAV communications. This includes serving the UAVs as aerial-UEs via uplink and downlink (i.e., the Uu interface) and supporting direct communication between UAVs (i.e., via the PC5 or sidelink interface). The latter is to support the following two use cases:
Broadcast remote ID (BRID): the Federal Aviation Administration (FAA) in the US has issued a rule on remote ID of drones in 2021. According to this rule, unless flying in dedicated zones, all drones in the US are required to have remote ID capability. Remote ID will provide information about drones in flight, such as the identity, location, and altitude of the drone and its control station or take-off location. Authorized individuals from public safety organizations may request identity of the drone's owner from the FAA.
Collision Detection and Avoidance (DAA): UAVs are able to detect the presence of one another and to react to avoid collisions.

In fact, in Section 5.2.2. of 3GPP TS 22.125, it is required that the 3GPP system support the broadcasting of UAV identity and other information related to UAV's speed and route over the PC5 interface for the purpose of collision detection and avoidance. Moreover, the UAV-to-UAV communication over PC5 should be able to support regularly broadcasted messages with certain payload size and latency requirements, both in network coverage and out of network coverage.

So far, 3GPP working group RAN2 has agreed that the BRID message and DAA message will be conveyed in the PC5-U (i.e., PC5 User Plane) protocol stack. That means these messages will be treated as an ordinary data packet at Layer 2 (i.e., PDCP/RLC/MAC) in the protocol stack. FIG. 2, which is reproduced from 3GPP TS 38.300, v17.4.0, depicts the PC5 user plane protocol stack.

In NR sidelink, typically, an application layer message/packet will be classified into different QoS flows by a higher layer before passed down to the PC5-U. This is shown for V2X messages in FIG. 3, which illustrates the per-flow PC5 QoS model for NR PC5 and which is reproduced from 3GPP TS 23.287, v17.6.0.

In case of UAV communication over sidelink, a similar process is being defined in the SA2 working group, where an A2X layer is used in place of the V2X layer in FIG. 3.

In Release 18, it was also agreed that only mode-2 scheduling (i.e., UE autonomous resource allocation mode) is supported.

### Unmanned Aircraft Systems (UAS) Traffic Management (UTM)

It is of utmost importance to keep the airspace safe and accessible. Therefore, a system called UTM is being developed in different parts of the world to manage the traffic of the UAS (a UAS is composed of a UAV and a UAV controller used by an operator with unique credentials and identities.) According to NASA, UTM is a collaborative, automated, and federated airspace management approach that enables safe, efficient, and equitable small UAS operations at scale. The concept of UTM is being adopted and implemented by many countries and regions in the world, e.g., in the US, Europe, Japan, Australia, etc.

The UTM provides many flight-related functions for UAVs and UAV operators, for example:
Remote identification: enabling UAV identification.
Operation planning: flight planning considering various aspects e.g., UAV performance, whether condition.
Operator messaging: message exchange between operators for e.g., position and status information.
FAA messaging: providing on-demand, periodic, or event-triggered communications with FAA systems to meet regulatory requirements.
Mapping: information about airspace restrictions, obstacles, and sensitive regions.
Conflict advisory: real-time alerting for collision avoidance.

Mobile networks can enable reliable connectivity between the UAV and its controller. Meanwhile, UTM can connect to the UAV and the UAV controller through the core network and the radio access network. An illustration of UAS-to-UTM connectivity is provided in FIG. 4.

In parallel, the Federal Aviation Administration (FAA) in the US has issued regulations regarding the remote identification of UAVS. According to this rule, after a certain date, all drones flown in US airspace must have remote identification capability, referred to herein as “remote ID.” The FAA rules. See, for example, the regulations at 14 CFR 89. Remote ID will provide information about drones in flight, such as the identity, location, and altitude of the drone and its control station or take-off location. Authorized individuals from public safety organizations may request identity of the drone's owner from the FAA.

Clearly, it is of interest for 3GPP to specify mechanisms for broadcasting remote ID of drones. One viable solution is to use the PC5 (also known as Sidelink) interface briefly discussed above. There currently exist certain challenge(s). So far, sidelink has been designed mainly for ground communications, such as for V2X. But several regulators (across the world) for the UAV are mandating the broadcast of an ID (as detailed above) over sidelink for identification by regulatory authorities for e.g., police, fire department. As also detailed above, 3GPP in Rel-18 is currently working on standardizing this aspect. However, to enable sidelink-based UAV communications, several technical issues arise for the coexistence of sidelink-based UAV and other sidelink services. The main issue is the reliability of transmission for the regulatory messages (BRID/DAA) over sidelink. And, as mentioned above, in the current release only mode-2 resource allocation (i.e., UE-autonomous sensing-based mechanism) is supported. But transmissions in the mode-2 mechanism are prone to pre-emption and collision and with tight regulatory requirements, the current mechanisms are insufficient.

A possible solution involves separate (pre-)configured sidelink resource pool(s) for UAV messages vs. V2X messages and/or for regulatory UAV messages vs. non-regulatory UAV messages. Some indicators can be sent by the network to the UE to indicate what type of sidelink services/messages can be sent in a certain resource pool. However, as described above, in the UE, the BRID/DAA message is treated as an ordinary data packet at radio layers (Layer 2 and PHY layer in FIG. 2). In other words, there is no way for radio (Access Stratum (AS)) layers to differentiate a BRID message or a DAA message from other types of UAV messages. As a result, the UE may send a non-regulatory UAV message in a resource pool dedicated to BRID or DAA messages. This undermines the value of having dedicated resource pools for different types of messages. The same issues applied to V2X vs. UAV messages.

Thus, there are at least two issues at the UE:
First, how to differentiate different types of sidelink-based communications (e.g., V2X vs. UAV). This is a relevant question both when V2X and UAV use different carrier frequencies and when they use the same carrier frequency.
Second, how to differentiate regulatory/safety UAV communication (e.g., BRID/DAA) from non-regulatory UAV communications (e.g., UAV-to-UAV communication for sensor sharing).

### SUMMARY

As introduced in the previous section, UAVs may need to broadcast an ID and other information about the UAV. This information may be received by other entities to determine which UAVs are in the area, and further info about them, e.g., location and velocity, etc.

The UAV ID may be communicated over a channel for UE-to-UE communication (e.g., Sidelink). However, other information, which may be of different importance compared to the UAV ID, may also be communicated over this channel. As a result, the channel may be filled with such other information which may limit the possibility for UEs to communicate the UAV IDs. This may result in that the requirements for UAV ID broadcasting cannot be fulfilled.

Certain aspects of the disclosure and their embodiments may provide solutions to these or other challenges. These embodiments include techniques, apparatuses, and systems for communicating identification information for UAVs. Also described herein is the use of an indicator in at least the regulatory messages (BRID and/or DAA messages), where this indicator is interpretable by the AS-layer (PDCP/RLC/MAC/PHY) in the 3GPP radio protocol stack to, so that the UE can transmit such messages in the corresponding dedicated resource pool. One or more embodiments thus involve a new indicator that allows a UE to differentiate regulatory/safety messages (BRID/DAA) from other UAV and non-UAV messages at the AS-layer (PDCP/RLC/MAC/PHY), so that the UE can transmit these regulatory/safety messages on a specific sidelink resource pool.

An example method, in a wireless device in, on, or forming part of a UAV, comprises determining to transmit UAV identification (ID) information; determining one or more resources for transmitting the UAV ID information, the determined one or more resources being specifically designated for use in transmitting UAV ID information; and transmitting the UAV ID information using the determined one or more resources. In some cases, the determined one or more resources are specifically designated for use in transmitting UAV ID information, to the exclusion of transmitting non-UAV-related information.

Another example method, in a network node of a wireless network, comprises the step of indicating, to at least one wireless device in, on, or forming part of a unmanned aerial vehicle (UAV), a designation of one or more resources for transmitting UAV ID information as being specifically for use in transmitting UAV ID information. Again, in some cases, the determined one or more resources are specifically designated for use in transmitting UAV ID information, to the exclusion of transmitting non-UAV-related information.

Certain embodiments may provide one or more of the following technical advantage(s). At least one embodiment provides a mechanism that allows UE to send a sidelink message using an allowed resource pool, for fulfillment of QoS requirements. In particular, regulatory or safety-related UAV messages like BRID or DAA message can be sent using a dedicated resource pool not shared by other types of UAV messages and/or non-UAV messages.

### BRIEF DESCRIPTION OF THE FIGURES

FIG. 1 illustrates a scenario where the network is reconfiguring an aerial UE based on its flying altitude.

FIG. 2 illustrates the PC5 user plane protocol stack.

FIG. 3 shows the per-flow PC5 QoS model for NR PC5

FIG. 4 shows UAS-to-UTM connectivity.

FIG. 5 illustrates an example UE 10 that includes a protocol stack configured for differentiated handling of one or more types of sidelink messages.

FIG. 6 illustrates an example protocol stack that supports sidelink communications.

FIG. 7A is a process flow diagram illustrating an example method, according to some embodiments.

FIG. 7B is a process flow diagram illustrating another example method, according to some embodiments.

FIG. 8 illustrates another example method, carried out by a UE, according to some embodiments.

FIG. 9 illustrates another example method, carried out by a network node, according to some embodiments.

FIG. 10 illustrates another example method, carried out by a UE, according to some embodiments.

FIG. 11 illustrates another example method, carried out by a network node, according to some embodiments.

FIG. 12 illustrates an example communication system.

FIG. 13 is a block diagram illustrating features of an example UE.

FIG. 14 illustrates an example network node.

FIG. 15 is a block diagram of a host.

FIG. 16 is a block diagram illustrating a virtualization environment.

FIG. 17 shows a communication diagram of a host communicating via a network node with a UE over a partially wireless connection.

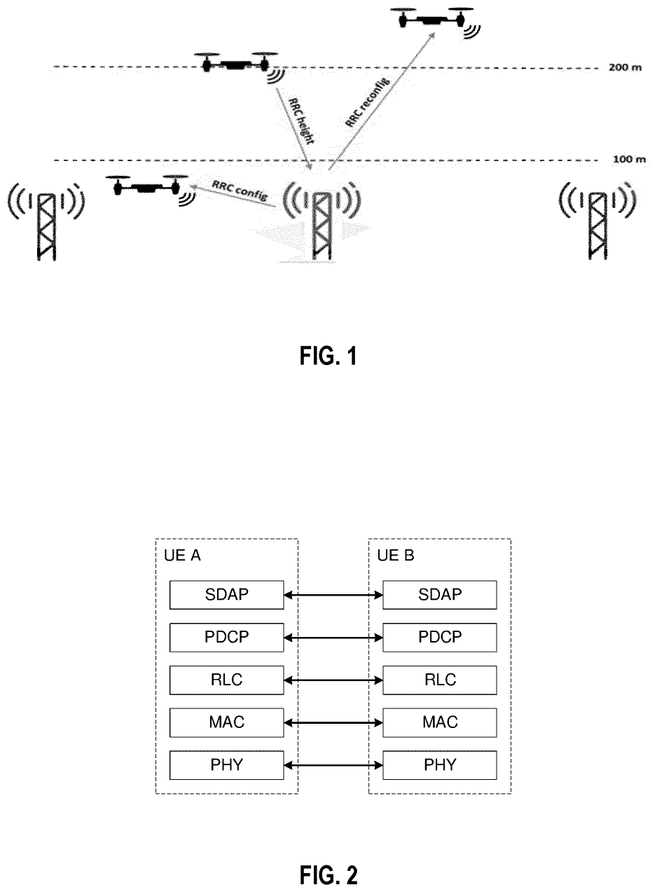

### DETAILED DESCRIPTION

Some of the embodiments contemplated herein will now be described more fully with reference to the accompanying drawings. Embodiments are provided by way of example to convey the scope of the subject matter to those skilled in the art.

This disclosure uses the term UAV, but the solution(s) described herein apply to any type of aerial User Equipments (UEs), which are UEs installed in, mounted on, or attached to an airborne device such as drones or other kinds of aircraft, e.g., helicopters, airliners, etc. The disclosed solution(s) also apply to other types of sidelink-based communication, e.g., V2X, public safety, etc.

The term “UAV ID information” in this invention describes a set of information, related to a UAV, that includes but is not necessarily limited to an identifier of the UAV. The contents of the UAV ID information, i.e., the parameters and fields that make up the UAV ID information may be predetermined, e.g., by specification, regulation, or the like. Thus, besides the UAV identifier (ID) itself, UAV ID information may comprise other information related to the UAV, information about the UAVs position, height, velocity, time when the position/height/velocity was decided, information about the UAV's flight, such as its launch point, the flight operator, duration, etc.

As indicated above, the term “Layer 2” collectively denotes the PDCP/RLC/MAC layers in the PC5-U protocol stack (see FIG. 2).

Some of the following embodiments are presented using the concept of a resource pool, but they are applicable generally to radio resources for sidelink communications. Such resources may be a set of time and/or frequency resources, a resource pool, a bandwidth part, a subchannel, a sub-band, etc. In the following, the terms “set of resources” and “resource pool” are used interchangeably to identify a pool of radio resources (i.e., a plurality of radio resources, each of which alone is suitable for transmission or reception use) from which a UE needs to pick a radio resource for performing a transmission or reception. This pool of radio resources is common for multiple UEs and thus it may happen that a certain radio resource is already selected by another UE, in which case no transmission or reception by other UEs is possible.

Some of the embodiments described herein are directed to the separating of BRID/DAA (regulatory/safety) messages. Embodiments need not be restricted to only the separating of BRID/DAA messages, as the underlying principle applies to any type of communication over a sidelink that requires a separate set of resources.

According to several of the techniques described herein, the network provides a set of resources specifically for use by UEs to communicate UAV ID information. By this is meant that certain resources, of several available resources, are set aside in some way for use in communicating UAV ID information. In some, but not all cases, these may be designated as not for use in communicating other things, such as non-UAV-related information or UAV-related UAV ID information that falls outside the scope of UAV ID information. In some cases, however, the designation of these resources as specifically for use in communicating UAV ID information may also allow the communication of other UAV-related information, perhaps only a certain designated subset of such information. Likewise, in some cases the designation of these resources as specifically for use in communicating UAV ID information may also permit the communication of non-UAV-related information. This might be, for example, limited to certain high-priority information identified by standard, hard-coding of the device, or by network configuration.

These resources, which may be referred to as UAV ID-specific resources, may be resources for UE-to-UE communication, i.e., resources that are not used to communicate between a UE and a network, but for a UE to communicate with other UEs. This UE-to-UE communication may be done over a sidelink, e.g., via the PC5 interface. In this case, this means that a dedicated sidelink resource pool is provided by the network specifically for the broadcasting of the UAV ID information. In some cases, the resource pool is only for transmission of UAV ID information (and not other UAV-related information). In other cases, the same resource pool may also be used, e.g., upon a network indication, for broadcasting other UAV-related information. In some embodiments, in the event that the network does not send any explicit or implicit indication to the UE that this dedicated resource pool can be used also for other UAV-related information that is not part of the UAV ID information, than the UE may use other existing set of resources for transmitting and receiving other UAV-related info.

The network may, in addition to the UAV ID-specific resources, provide other resources for UEs to communicate with other UEs for other purposes, e.g., to communicate non-UAV-related information.

This is beneficial since communication of UAV ID information and communication of other information may be of different importance, and hence the network can assign different amount/properties of the resources to suit the need/importance of what is communicated. The prioritization can be on the radio resource level, meaning that each radio resource has a priority based on the communication that the UE has to perform, or on a radio resource pool level, meaning that that is only one priority for the entire group of radio resource.

With this approach, a UE that wishes to communicate with another UE thus determines what type of communication should be done with the other UEs. In some embodiments, if the communication is for communicating a UAV ID, the UE then selects one or more resources from resources that are assigned for communication of UAV ID information. If the UE intends to communicate something else, for example for communicating messages related to detection and avoidance, or communicating user plane data which may contain for example the flight path plan of the UE, the UE would use other radio resource pools, either the existing (legacy) ones or, in some cases, a new one just for UAV-related information that are not the UAV ID.

In some embodiments according to the techniques described herein, the UE is in out-of-coverage mode and thus the UE uses a preconfigured set of resources specifically designated for use in communicating UAV ID information. In some embodiments, this set of preconfigured resources are dedicated resources for UAV communications and can be used by UAVs (UEs) that have UAV subscription authorized for UAV operations.

In some of these embodiments, the pre-configured set of radio resources (or resource pool) is hard-coded (or clearly specified) in the specification. This means that the set of radio resources to be used when in out-of-coverage situation is either saved in the internal UE memory or saved within the mobile subscription card (sim card) used by the UAV. Note that even if the set of radio resources is hard-coded or specified in a specification, each mobile operator or regulator may configure a dedicated set of radio resources that is just a subset of the one hard-coded in the specification.

Due to regulatory aspects, it may be that dedicated resources for communication of UAV ID information are seen to be so important that dedicated preconfigured resources are required to be preconfigured in SIM cards for the UEs that have the subscription-based authorization from the operator. In yet another variation, whether or not this is mandated may depend on the country of operation for the service provider.

If the UE is in coverage, the network may indicate to the UE whether a set of radio resources or a resource pool is for UAV communication or not and whether or not this set or pool can be used only to communicate the UAV ID or not. This may be done by indicating a flag associated with the radio resources or resource pool configuration. For example, a set of resources may be provided in a field carrying a signaling structure. Associated to that signaling structure may be a flag/field which is set to a first value to indicate that the associated resources are for UAV ID communication, while if set to a second value it indicates that the resources are not for UAV ID communication. If the flag is set it is determined that the resources can be used for UAV ID broadcasting, otherwise the resources are not specifically designated for UAV ID broadcasting.

Another approach is that the resources are determined to be for UAV ID broadcasting if the resources are provided in a certain field (or set of fields) within a message. For example, a message may comprise a set of fields and the network may provide/configure the resources for UAV ID broadcasting by indicating those resources in a certain field (or set of fields) which are different than a field that provides other resources. The UE would determine whether a resource is for UAV ID broadcasting or not depending on in which field the resources are provided. For example, a message/signaling structure may have field A, field B, and field C which all can indicate resources that the UE can use for communication with other UEs (e.g., sidelink resources). According to this approach it may be specified that resources in field A can be used for UAV ID broadcasting, while resources provided in field B and field C and used for other types of communication (i.e., non-UAV ID broadcasting communication).

Another approach is that the resources for UAV ID broadcasting are provided in a particular message (given that this is sent to the UE via dedicated RRC or in system information—SIB). For example, the network may provide multiple messages with resources, out of which one of these messages contain resources for UAV ID broadcasting, while other messages contain resources which are not for UAV ID broadcasting. The UE would determine whether a resource is for UAV ID broadcasting depending on in which message the resources are provided in.

In some embodiments, the network may also indicate, in association with each radio resource or resource pool, whether this pool can be used for doing (sidelink) broadcast or sidelink discovery, in addition to whether this can also be used for communicating the UAV ID. In this case, the UE may use (sidelink) broadcast or sidelink discovery based on the set of radio resources (or resource pool) selected or indicated eventually by the network.

In some embodiments, an indicator interpretable by a first layer(s) (e.g. Layer 2 or specifically PC5-U protocol layers) in a UE in or associated with a UAV is added to or included in a second layer(s) (e.g. an application-layer) message before the message is passed down to the first layer. The indicator indicates a message type/service. For example, the indicator indicates whether the message is one of: a BRID message, a DAA message, a BRID or DAA message, a non-UAV message. From the perspective of the UE, this is an indication from the NAS-layer to the AS-layer.

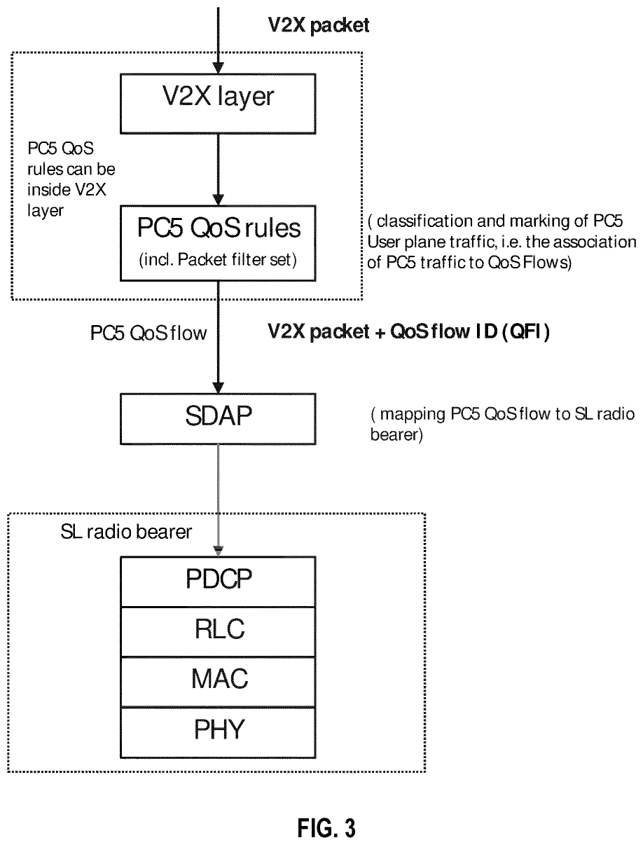

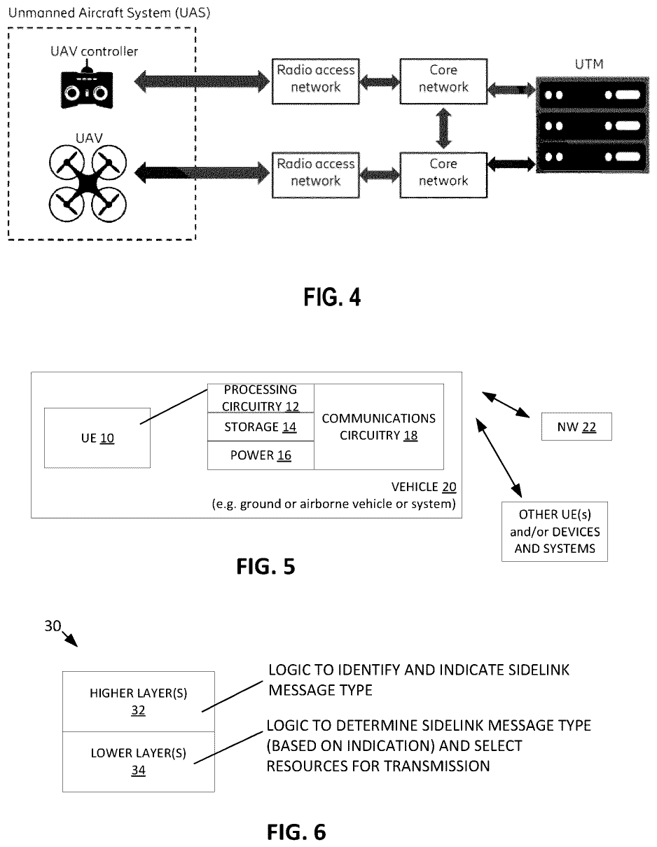

In some embodiments, an explicit indicator (e.g., an integer) is added to or included in the application layer message. For example, this can be done by the A2X layer in the protocol stack (see FIG. 3 with V2X replaced by A2X).

In some embodiments, the indicator may be implicit, e.g., in the form of a dedicated QoS flow ID assigned to the message to be transmitted. For example, a dedicated QoS flow ID is assigned to the BRID and/or DAA message while other UAV messages and/or non-UAV messages are assigned one of other common values for QoS Flow ID (see FIG. 3 with V2X replaced by A2X).

In some embodiments, the MAC layer selects resources for transmitting a MAC PDU corresponding to the message from a resource pool associated with the indicator. For example, if the indicator indicates that the message is a BRID or a DAA message, the corresponding MAC PDU is transmitted using resources from the resource pool dedicated to transmitting BRID/DAA message. In another example, a BRID/DAA message can be transmitted in any sidelink resource pool for UAV communications, while a non-BRID/DAA message cannot be transmitted in a resource pool dedicated to BRID/DAA messages.

In some embodiments, a Logical Channel Prioritization (LCP) restriction can be applied at the MAC-layer such that the data originating from a particular radio bearer/logical channel (LCH) can be transmitted only on a certain set of resource pools. The configuration with information on which LCH is associated to the BRID/DAA messages can be provided by the higher layers of the UE, e.g., the RRC-layer. It can also be configured by the network, i.e., gNB either using the common or dedicated sidelink configuration.

At the higher layers, based on information from the application layer (as described below), the UE can also map the BRID/DAA data to specific bearers (e.g., a Data Radio Bearers (DRBs)). The DRBs have a one-to-one mapping to the LCHs at the MAC-layer. The network can also provide the DRB ID/LCH ID associated to transmission of BRID/DAA (regulatory) messages in either using a common or dedicated sidelink configuration.

In some embodiments, based on the indication from the NAS-layer to the AS-layer, in mode-2 resource allocation, the PHY layer in the UE can prioritize the sensing and resource selection in resource pools associated to the LCH carrying BRID/DAA messages. In another aspect, the UE can always perform full sensing in resource pools associated with BRID/DAA messages. Else, the UE can perform partial sensing.

In some embodiments, based on the indication from the NAS-layer to the AS-layer, the AS-layer transmits BRID/DAA messages in the sidelink resource pools which have HARQ feedback disabled (also known as HARQ-less resource pools). In so doing, the BRID/DAA messages can avoid the interference from transmissions that require HARQ feedback. Another advantage of this approach is no separate resource pools are needed for BRID/DAA messages, which help mitigate resource fragmentation.

In some related embodiments, the AS-layer abstains from sending BRID/DAA messages in sidelink resource pools which have HARQ feedback enabled. Optionally, the AS-layer only abstains from sending BRID/DAA messages in a resource pool with HARQ feedback enabled if the UE detects that a level of channel occupancy in the resource pool has exceeds a certain threshold.

In some embodiments, if the UAV UE is configured (for e.g., an IE is included in a DL RRC message) with a separate resource pool for transmission of BRID/DAA messages, the AS-layer of the UAV UE will use those resources to transmit BRID/DAA messages. If not configured (for e.g., no IE is included in a DL RRC message), the AS-layer of the UAV UE will use the shared resource pools for transmission of BRID/DAA messages. This provides the flexibility to the network whether to configure separate resource pools. In another aspect of this embodiment, in the existing DL RRC message carrying the resource pool information, can include a specific flag for indicating whether BRID/DAA messages are allowed to be transmitted on one or more of the configured resource pools as included in the existing DL RRC message. The existing DL RRC messages are SL-BWP-PoolConfigCommon and SL-BWP-PoolConfig. In case the UE is configured with more than one resource pool in which BRID/DAA messages can be sent, the UE may select one of them, e.g. do a random selection.

In some embodiments, the A2X layer can identify the BRID/DAA messages based on information provided by the application layer. In another aspect, the A2X layer can read the header of the packets to classify them as BRID/DAA messages (regulatory) and other messages. The header can include tag for BRID/DAA messages, specific/default priority value or IP header of the application generating BRID/DAA messages.

In another aspect, the indication from the NAS layer to the AS layer can be combined with the packet delay budget (PDB) parameter.

Note that the above embodiments need not be restricted to only separating BRID/DAA (regulatory/safety) messages, as the same principle can also be applied to command and control messages. For example, in the case of UAV command and control (often referred to as C2) over sidelink (e.g., to extend the communication range via relaying), the disclosed solutions can be used to achieve high QoS requirements for C2 messages.

FIG. 5 illustrates an example UE 10 that includes a protocol stack configured for differentiated handling of one or more types of sidelink messages. In one or more embodiments, the UE 10 is integrated in or included with a vehicle, such as an automobile or an unmanned guided vehicle, and it provides for differentiated handling of one or more types of sidelink messages, such as those associated with operation of vehicle. In at least one such embodiment, the UE 10 provides for differentiated handling of sidelink messages associated with regulatory compliance and/or safe operation of the vehicle.

In one or more embodiments, the vehicle in question is an aerial vehicle, e.g., a UAV. The UE 10 in such cases may be referred to as an “aerial UE.” In the aerial UE context, the UE 10 may provide differentiated handling for sidelink messages specifically related to flight operations-broadly referred to as “UAV messages.” Alternatively, the UE 10 may provide differentiated handling only for certain types of UAV messages, such as those needed for regulatory compliance (e.g., BRID messages) and/or safe operation (e.g., DAA messages).

In one or more embodiments, “differentiated handling” refers to selection by the UE of resources for sidelink message transmission, in dependence on the type of sidelink message to be transmitted. Thus, in one or more embodiments, the UE 10 provides differentiated resource selection for different types of sidelink messages outgoing from the UE 10. For example, in one or more embodiments, the UE 10 receives configuration information from a wireless communication network, indicating a first set of one or more resource pools and a second set of one or more resource pools. In an example configuration, the first set of one or more resource pools is allocated for the transmission of one or more particular types of sidelink messages, and the second set of one or more resource pools is allocated for the transmission of sidelink messages other than those one or more particular types. In this way, the network avoids or at least reduces potential congestion and sidelink transmission collisions for the one or more particular types of sidelink messages.

The UE 10 in the illustrated example includes processing circuitry 12 (e.g., one or more microprocessors or other digital circuitry), storage 14 (one or more types of memory or other computer-readable media), a power source 16 (such as a battery), and communications circuitry 18. The communications circuitry 18 at least includes a cellular radio modem configured for communicating with cellular communications networks via one or more types of Radio Access Technologies (RATs).

In at least one embodiment, the communications circuitry 18 is configured for communications with communications networks operating according to 3GPP specifications, e.g., Fifth Generation (5G) networks using the New Radio (NR) air interface. As noted, the UE 10 may be attached to or integrated in a UAV 20 that includes flight systems, etc., and the UE 10 uses its communications circuitry 18 for communicating with one or more wireless communication networks 22, e.g., 3GPP cellular networks, and for communicating with other UEs, devices, or systems, e.g., using sidelink communications for A2X and V2X communications.

The UE 10 implements a protocol stack 30 that supports sidelink communications, with FIG. 6 illustrating one embodiment. The sidelink communications use resources configured by the network 22, for example. Here, “resources” comprise radio transmission resources, such as time-frequency resources.

The protocol stack 30 comprises, for example, a PC5-U protocol stack, such as shown above in FIGS. 2 and 3, but with the logical processing modifications shown in FIG. 6. The logical processing modifications include higher-layer processing logic and lower-layer processing logic. Here, “lower layer” refers, for example, to the Access Stratum (AS) layer of the protocol stack 30, which includes the PDCP, RLC, MAC, and PHY layers. “Higher layer” refers to one or more layers above the AS layer, such as the A2X/V2X layer shown in FIG. 3. In one or more examples, lower layer refers to the AS layer and higher layer refers to the Non-Access Stratum (NAS) layer, where the AS “layer” and the NAS “layer” may each span more than one individual layer illustrated in the example protocol stack 30.

In any case, the higher-layer processing at issue here has knowledge of the “message type” of outgoing sidelink messages, whereas, without benefit of the advantageous techniques disclosed herein, the lower-layer processing would not know the message types of outgoing sidelink messages.

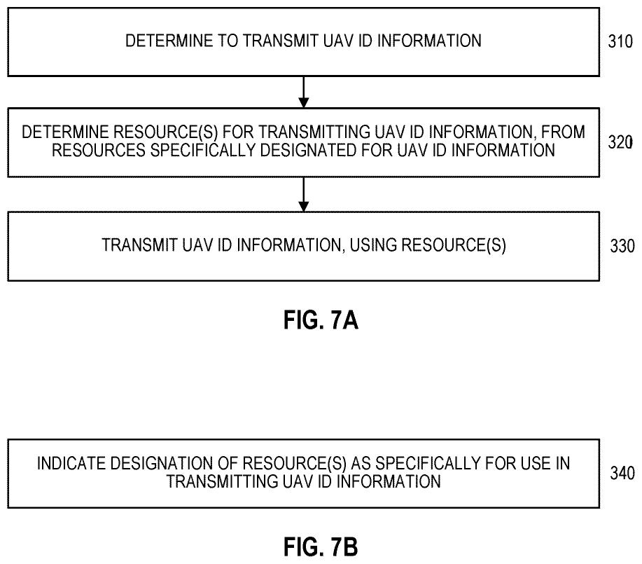

FIG. 7A illustrates a process flow diagram for a generalized method, according to several of the techniques described above, as carried out in a wireless device in, on, or forming part of a unmanned aerial vehicle (UAV). It should be understood that the term “wireless device” is used herein as a generalization of the 3GPP term “UE,” and refers to a device configured to wireless communicate with a wireless network and/or via peer-to-peer, or “sidelink” communications. Accordingly, the term wireless device encompasses, but is not limited to, UEs as specified by 3GPP specifications. The illustrated method, and the several variations described below, should be understood as encompassing and/or complementing several of the techniques described above, such that variations described above are applicable to the method of FIG. 7A, and vice versa.

The method illustrated in FIG. 7A comprises, as shown at block 710, the step of determining to transmit UAV identification (ID) information. As noted above UAV ID information includes an identifier for the UAV, but may also include other UAV-related information, in various embodiments.

As shown at block 720, the method further comprises determining one or more resources for transmitting the UAV ID information, where the determined one or more resources are specifically designated for use in transmitting UAV ID information. In some embodiments, this designation may be that the resources are designated for use in transmitting UAV ID information, to the exclusion of transmitting non-UAV-related information. The method still further comprises transmitting the UAV ID information using the determined one or more resources, as shown at block 730. This transmission may be a peer-to-peer, or sidelink, wireless transmission, in some embodiments or instances.

Various examples of how the resources are allocated, identified, and selected were discussed above. For example, determining the one or more resources for transmitting the UAV ID information comprises selecting the one or more resources from a plurality of resources specifically designated for use in transmitting UAV ID information. In various embodiments or instances, this plurality of resources may be predetermined by hard coding or network configuration. In some of these and in others, the plurality of resources is one of multiple sets of resources available to the wireless device for use in transmitting information.

In some embodiments, the method comprises selecting the one of the multiple sets of resources using information received by the wireless device from a wireless network, indicating that the one is specifically designated for use in transmitting UAV ID information. This information might be received via RRC signaling, or example, and/or via a System Information Block (SIB) broadcasted by the wireless network.

In some embodiments or instances, as discussed above, the method may comprise determining that the wireless device is out of coverage of a wireless network, where the determining of the one or more responses is based on determining that the wireless device is out-of-coverage. In some of these and in other embodiments or instances, the method may further comprises determining whether the transmitting of other UAV-related information in the one or more resources is permitted and, responsive to determining that the transmitting of other UAV-related information in the one or more resources is permitted, transmitting information in addition to the UAV ID information.

FIG. 7B shows a corresponding method, as might be implemented in a network node in or connected to a wireless communication system, for carrying out one or several of the techniques described above. Again, the illustrated method, and the several variations described below, should be understood as encompassing and/or complementing several of the techniques described above, such that variations described above are applicable to the method of FIG. 7B, and vice versa. Furthermore, multiple ones of the numerous variations described herein may be implemented in and/or carried out by the same network node, in some embodiments. The network node might be an eNB or a gNB, for example.

As shown at block 740, the illustrated method comprises indicating, to at least one wireless device in, on, or forming part of a unmanned aerial vehicle (UAV), a designation of one or more resources for transmitting UAV ID information as being specifically for use in transmitting UAV ID information. Again, in some embodiments, this designation may be that the resources are designated for use in transmitting UAV ID information, to the exclusion of transmitting non-UAV-related information.

The variants discussed above are applicable to the method shown in FIG. 7B. Thus, for example, the designation may correspond to a plurality of resources specifically designated for use in transmitting UAV ID information. This plurality of resources might be one of multiple sets of resources available to the wireless device for use in transmitting information. The indicating might be performed via RRC signaling, for example, or via the broadcasting of a SIB.

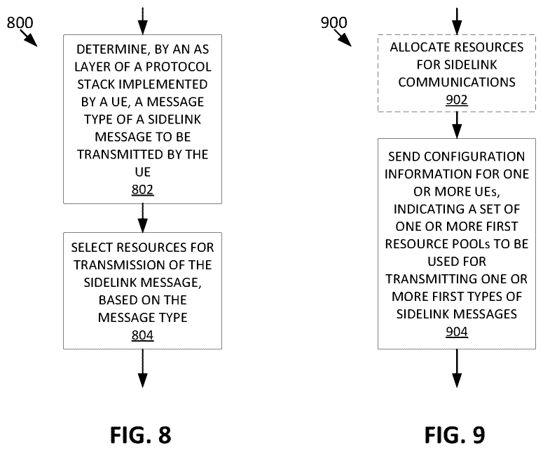

FIG. 8 illustrates a method 800 according to one embodiment, where a lower layer in the protocol stack 30 of the UE 10 determines a message type of a sidelink message to be transmitted by the UE 10 (Block 802), and selects resources for transmission of the sidelink message, based on the message type (Block 804). Additionally, or alternatively, the UE 10 selects the bearer(s) used for transmitting a sidelink message and/or controls how it performs resource sensing for transmitting the sidelink message, in dependence on the type of the sidelink message.

FIG. 9 illustrates a method 900 according to one embodiment, where a network node, e.g., an eNB or other type of base station or access point, configures resource usage for sidelink messaging by sending configuration information for one or more UEs (Block 904). In particular, the configuration information indicates a set of one or more first resource pools allocated for transmitting one or more first types of sidelink messages.

As noted above, the disclosed techniques may be used to differentiate between sidelink messages relating to UAV operations versus sidelink messages not related to UAV operations. For example, the network 22 configures a set of one or more first resource pools for use in transmitting sidelink messages related to UAV operations and configures a set of one or more second resource pools for transmitting other sidelink messages-those not specifically involving UAV operations.

In another example, the technique is used for differentiated handling of specific types of sidelink messages, such as UAV-related sidelink messages that are of a regulatory type (required by applicable governmental or other regulation) and/or of a safety type. Thus, sidelink messages carrying critical information may be handled differently at the lower layers of the UE's protocol stack, including differentiated selection of the resources used for message transmission. While this differentiated handling offers certain advantages with respect to aerial UEs or UEs integrated in ground vehicles, the disclosed techniques for differentiated handling—message type recognition at a higher-level layer in the UE's sidelink protocol stack and corresponding indication of message to one or more lower-level layers for differentiated resource selection—may be used in a variety of sidelink communications scenarios. For example, the techniques allow for differentiated handling of sidelink messages with respect to different types of sidelink messages, where the different types corresponding to different applications or different types of applications executing on a UE and/or different signaling purposes or priorities within a given application executing on the UE.

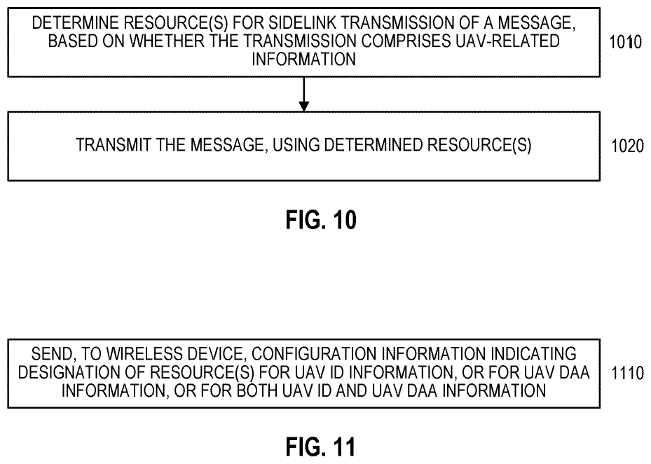

FIG. 10 is a process flow diagram illustrating another example method as carried out by a wireless device in, on, or forming part of a UAV. This method should again be understood as encompassing many of the techniques described above, from the perspective of the wireless device.

As shown at block 1010, the method comprises determining resources for a sidelink transmission of a message by the wireless device, where this determining is based on whether the transmission comprises UAV-related information. As shown at block 1020, the method further comprises transmitting the message, using the determined resources.

In some embodiments, the method comprises determining to transmit UAV ID information and the step of determining resources for the sidelink transmission of the message comprises determining one or more resources that are specifically designated for use in transmitting UAV ID information. It should be appreciated that this variation of the method shown in FIG. 10 overlaps with that illustrated in FIG. 7A and described above.

In some embodiments, the method comprises determining to transmit UAV detection and avoidance (DAA) information, and determining resources for the sidelink transmission of the message comprises determining one or more resources that are specifically designated for use in transmitting UAV-related information. In some of these embodiments, the determined one or more resources are specifically designated for use in transmitting UAV ID information, to the exclusion of transmitting non-UAV-related information.

In some embodiments, determining the resources for the sidelink transmission of the message comprises selecting one or more resources from a plurality of resources specifically designated for use in transmitting UAV-related information. In various embodiments, the plurality of resources is predetermined by any one of more of: hard coding; network configuration; and pre-configuration information stored in a SIM or USIM. In some of these embodiments the plurality of resources is one of multiple sets of resources, or resource pools, available to the wireless device for use in transmitting information. In some embodiments, the method may comprise selecting the one of the multiple sets of resources using information received by the wireless device from a wireless network and indicating that the one is specifically designated for use in transmitting UAV ID information. This information might be received via RRC signaling or via a SIB, broadcasted by the wireless network, in some examples.

In some embodiments, the step of determining resources for the sidelink transmission of the message comprises interpreting an implicit or explicit indication associated with the message, the implicit or explicit indication indicating a message type of the sidelink message, and selecting resources for transmission of the sidelink message, based on the message type. Note that this variation of the method shown in FIG. 10 overlaps with the method illustrated in FIG. 8, as described above.

In some embodiments, the indication indicates that the message comprises UAV identification, ID, information, or that the message comprises UAV detection and avoidance (DAA) information, or that the message comprises UAV ID or DAA information. The method may, in some embodiments, comprise controlling the indication in an application layer of a protocol stack implemented in the wireless device and sending the indication to lower layers of the protocol stack, where the interpreting of the indication is performed in at least one of the lower layers of the protocol stack. This interpreting may be performed in a MAC layer of the protocol stack, for example.

In some embodiments, determining the resources comprises checking whether a Quality-of-Service Flow Identifier (QFI) associated with the sidelink message matches a QFI that is associated with messages carrying UAV ID information, or with messages UAV DAA information, or with messages carrying UAV ID or UAV DAA information.

FIG. 11 is a process flow diagram illustrating another example method as carried out by a network node of a wireless network. This method complements that of FIG. 10, and is a generalization of many of the techniques described above, from the perspective of the network node.

As shown at block 1110, the method comprises the step of sending, to at least one wireless device in, on, or forming part of a UAV, configuration information indicating: a designation of one or more resources as being specifically for use in transmitting UAV ID information, or for use in transmitting UAV detection and avoidance (DAA) information, or for use in transmitting either or both of UAV ID and UAV DAA information.

In some embodiments, the designation indicates that the one or more resources are specifically designated for use in transmitting UAV ID information, to the exclusion of transmitting non-UAV-related information. In some embodiments, the designation corresponds to a plurality of resources, e.g., a set of resources or one or more resource pools, specifically designated for use in transmitting UAV ID information. In some embodiments, the plurality of resources may comprise one of multiple sets of resources, or resource pools, available to the wireless device for use in transmitting information.

In various embodiments, the indicating is performed via RRC signaling or by broadcasting a SIB.

In some embodiments, the one or more resources for transmitting UAV ID information comprise a first resource pool, and the configuration information further indicates a second resource pool to be used for transmitting one or more sidelink messages other than UAV-related sidelink messages.

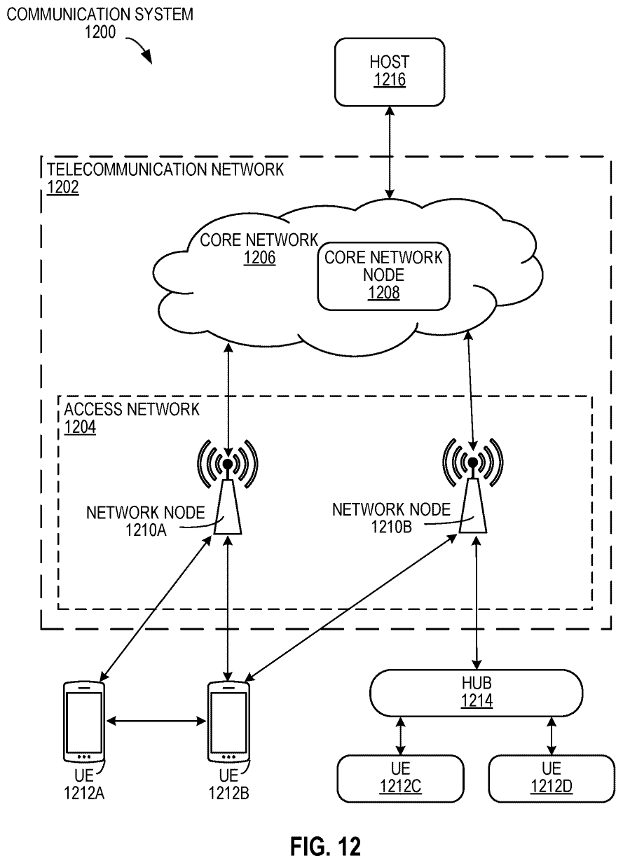

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1202 includes one or more Open-RAN (ORAN) network nodes. An ORAN network node is a node in the telecommunication network 1202 that supports an ORAN specification (e.g., a specification published by the O-RAN Alliance, or any similar organization) and may operate alone or together with other nodes to implement one or more functionalities of any node in the telecommunication network 1202, including one or more network nodes 1210 and/or core network nodes 1208.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node.

Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

One or more of the network nodes may be configured, in some embodiments, to allocate resources on a differentiated basis, to support more reliable/robust transmission of certain types of sidelink messages by the UEs. Further, one or more of the UEs may be associated with respective vehicles, such as automobiles, Autonomous Guided Vehicles (AGVs), or UAVs, and may perform differentiated handling of sidelink messages in that context.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202. The UEs may include UEs in, or on, or forming part of respective UAVs.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204.

Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

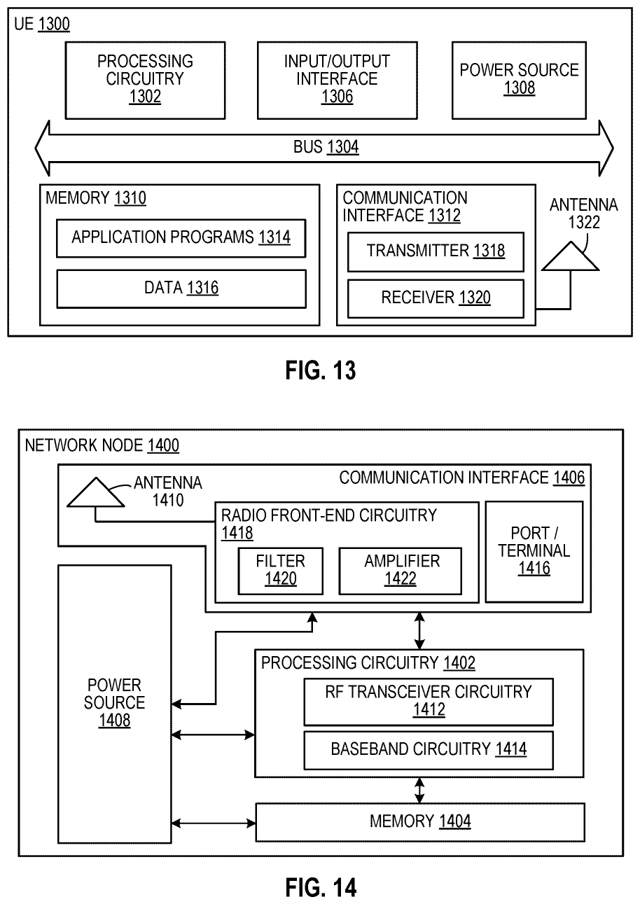

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

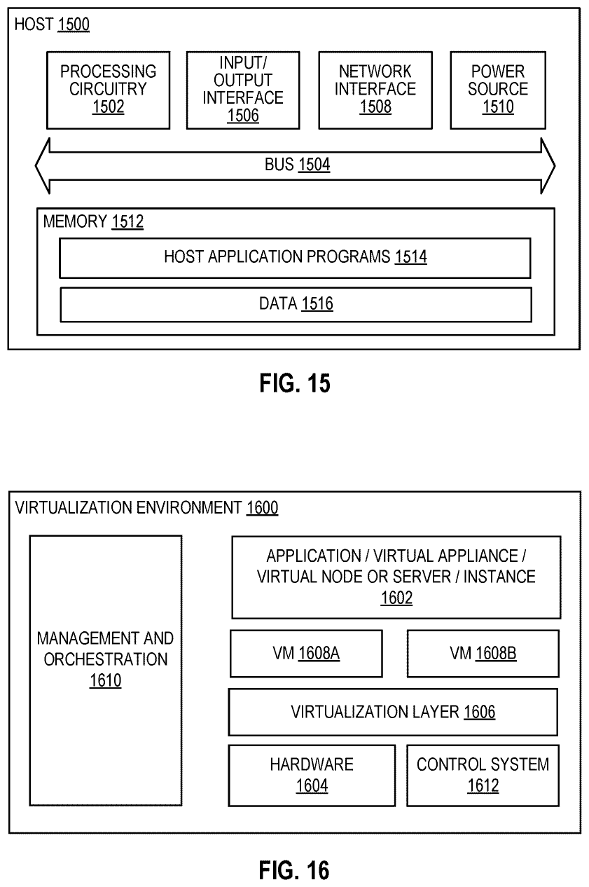

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

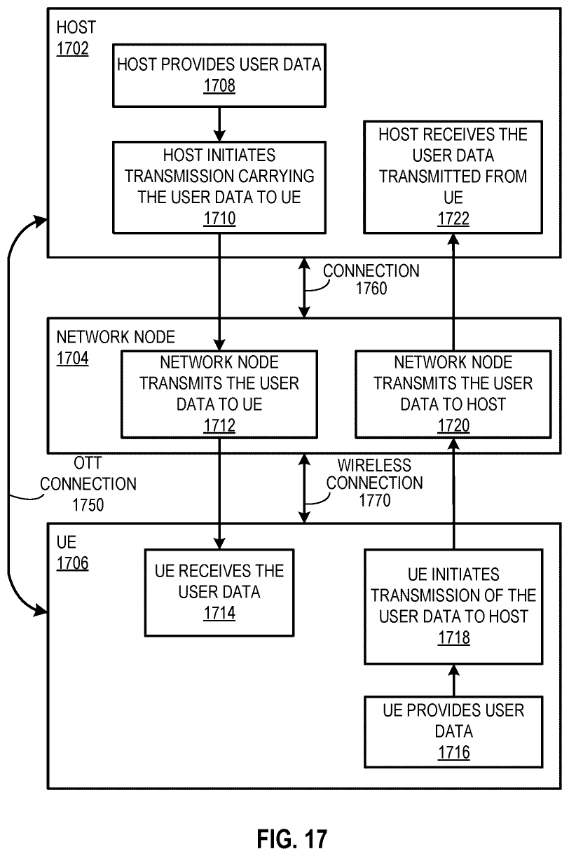

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve the power consumption of the UAV, while still maintaining a reasonable degree of responsiveness and avoidance of other aircrafts, thus providing for reliable communications to and through the UAV.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

### EXAMPLE EMBODIMENTS

Embodiments of the techniques, apparatuses, and systems described herein include, but are not limited to, the following examples:
A1. A method, in a wireless device in, on, or forming part of a unmanned aerial vehicle (UAV), the method comprising:
   determining to transmit UAV identification (ID) information;
   determining one or more resources for transmitting the UAV ID information, the determined one or more resources being specifically designated for use in transmitting UAV ID information; and
   transmitting the UAV ID information using the determined one or more resources.
A2. The method of example embodiment A1, wherein the determined one or more resources are specifically designated for use in transmitting UAV ID information, to the exclusion of transmitting non-UAV-related information.
A3. The method of example embodiment A1 or A2, wherein determining the one or more resources for transmitting the UAV ID information comprises selecting the one or more resources from a plurality of resources specifically designated for use in transmitting UAV ID information.
A4. The method of example embodiment A3, wherein the plurality of resources is predetermined by hard coding or network configuration.
A5. The method of example embodiment A3, wherein the plurality of resources is one of multiple sets of resources available to the wireless device for use in transmitting information.
A6. The method of example embodiment A5, wherein the method comprises selecting the one of the multiple sets of resources using information received by the wireless device from a wireless network, indicating that the one is specifically designated for use in transmitting UAV ID information.
A7. The method of example embodiment A6, wherein the information received by the wireless device is received via Radio Resource Control (RRC) signaling.
A8. The method of example embodiment A6, wherein the information received by the wireless device is received via a System Information Block (SIB) broadcasted by the wireless network.
A9. The method of any one of example embodiments A1-A8, wherein the method comprises determining that the wireless device is out of coverage of a wireless network, and wherein the determining of the one or more resources is based on determining that the wireless device is out-of-coverage.
A10. The method of any one of example embodiments A1-A9, wherein the method further comprises determining whether the transmitting of other UAV-related information in the one or more resources is permitted and, responsive to determining that the transmitting of other UAV-related information in the one or more resources is permitted, transmitting information in addition to the UAV ID information.
A11. The method of any one of example embodiments A1-A10, wherein said transmitting is a sidelink transmission to another wireless device.
A12. A method, in a network node of a wireless network, the method comprising:
   indicating, to at least one wireless device in, on, or forming part of a unmanned aerial vehicle (UAV), a designation of one or more resources for transmitting UAV ID information as being specifically for use in transmitting UAV ID information.
A13. The method of example embodiment A12, wherein the designation indicates that the one or more resources are specifically designated for use in transmitting UAV ID information, to the exclusion of transmitting non-UAV-related information.
A14. The method of example embodiment A12 or A13, wherein said designation corresponds to a plurality of resources specifically designated for use in transmitting UAV ID information.
A15. The method of example embodiment A14, wherein the plurality of resources is one of multiple sets of resources available to the wireless device for use in transmitting information.
A16. The method of any of example embodiments A12-A15, wherein said indicating is performed via Radio Resource Control (RRC) signaling.
A17. The method of any of example embodiments A12-A15, wherein said indicating is performed by broadcasting a System Information Block (SIB).
A18. The method of any one of example embodiments A12-A17, wherein the network node is one of:
   an eNB; and
   a gNB.
A19. A wireless device for use in or on an unmanned aerial vehicle (UAV), the wireless device being adapted to carry out a method according to any one of example embodiments A1-A11.
A20. A wireless device for use in or on an unmanned aerial vehicle (UAV), the wireless device comprising:
   radio circuitry; and
   processing circuitry operatively coupled to the radio circuitry and configured to, with the radio circuitry, carry out a method according to any one of example embodiments A1-A11.
A21. A network node, the network node being adapted to carry out a method according to any one of example embodiments A12-A18.
A22. A network node, comprising:
   radio circuitry; and processing circuitry operatively coupled to the radio circuitry and configured to, with the radio circuitry, carry out a method according to any one of example embodiments A12-A18.
A23. A computer program product comprising program instructions for execution by processing circuitry, the program instructions being configured to cause the processing circuitry to carry out a method according to any one of example embodiments 1-18.
A24. A computer-readable medium comprising, stored thereupon, a computer program product according to example embodiment A23.

Additional embodiments of the techniques, apparatuses, and systems described herein include, but are not limited to, the following examples:
B1. A method performed by a user equipment (UE) for sidelink communications, the method comprising:
   determining, by an Access Stratum (AS) layer within a protocol stack implemented by the UE for sidelink communications, a message type of a sidelink message to be transmitted by the UE; and
   selecting resources for transmission of the sidelink message, based on the message type.
B2. The method according to embodiment B1, wherein the protocol stack comprises a user plane protocol stack, and wherein the determining step comprises interpreting an implicit or explicit indicator associated with the sidelink message, and wherein the method further includes controlling the indicator in a higher layer of the protocol stack above the AS layer, the higher layer having knowledge of the message type of the sidelink message.
B3. The method of embodiment B1 or B2, wherein there is a first set of one or more resource pools allocated for transmission of sidelink messages of one or more first types, and there is a second set of one or more resource pools allocated for transmission of sidelink messages of one or more second types, and wherein selecting the resources for the transmission of the sidelink message comprises selecting the resources from the first set of one or more resource pools in response to the sidelink message being one of the one or more first types, and otherwise selecting the resources from the second set of one or more resource pools.
B4. The method of embodiment B3, further comprising receiving information from a wireless communications network indicating the first set of one or more resource pools and the second set of one or more resource pools.
B5. The method according to embodiment B3 or B4, wherein the first set of one or more resource pools are dedicated for transmission of sidelink messages of the one or more first types.
B6. The method according to any of embodiments B1-B5, wherein the one or more first types of sidelink messages comprise any one or more of sidelink messages associated with one or more particular types of applications running on the UE, sidelink messages sent for regulatory compliance, or safety-critical sidelink messages.
B7. The method according to any of embodiments B1-BB6, wherein the UE is attached to or integrated in a vehicle and wherein the one or more first types of sidelink messages are associated with operation of the vehicle, and wherein the one or more second types of sidelink messages are not associated with operation of the vehicle.
B8. The method according to embodiment B7, wherein the one or more first types of sidelink messages are Vehicle-to-Everything (V2X) type messages associated with operation of the vehicle in proximity to any one or more of other vehicles, infrastructure, or pedestrians.
B9. The method according to embodiment B7, wherein the vehicle is an aerial vehicle, and wherein the one or more first types of sidelink messages are associated with flight operations of the aerial vehicle, and wherein the one or more second types of sidelink messages are not associated with flight operations of the aerial vehicle.
B10. The method according to embodiment B7, wherein the vehicle is an aerial vehicle, and wherein the one or more first types of sidelink messages are associated with regulatory compliance of the aerial vehicle.
B11. The method according to embodiment B7, wherein the vehicle is an aerial vehicle, and wherein the one or more first types of sidelink messages are associated with safety-critical operations of the aerial vehicle, including at least collision avoidance.
B12. The method according to embodiment B1, wherein the UE is comprised in an unmanned aerial vehicle (UAV), and wherein selecting the resources for transmission of the sidelink message comprises determining whether to select the resources from a first set of one or more resource pools or a second set of one or more resource pools, in dependence on whether the sidelink message is a UAV message.
B13. The method according to embodiment B12, wherein the set of one or more first resource pools comprise resources dedicated for transmission of UAV messages.
B14. The method according to embodiment B12, wherein determining the message type comprises determining whether the message is of a first UAV message type, from among two or more UAV message types.
B15. The method according to embodiment B14, wherein, responsive to determining that the message is of the first UAV message type, the selecting step comprises selecting resources from the first set of one or more resource pools, which set is dedicated for sending sidelink messages of the first UAV message type.
B16. The method according to embodiment 15, wherein the first UAV message type includes at least one of regulatory messages or safety messages associated with UAV operation.
B17. The method according to embodiment 14, wherein, responsive to determining that the message is not of the first UAV message type, the selecting step comprises selecting resources from the second set of one or more resource pools, which set is allocated for sending any sidelink message that is not of the first UAV message type.
B18. The method according to embodiment B1, wherein the determining comprises checking for an explicit indicator included for the sidelink message by a higher layer in the protocol stack.
B19. The method according to embodiment B18, wherein checking for the explicit indicator comprises one of: checking for the presence of the explicit indicator or checking for a particular value of the explicit indicator.
B20. The method according to embodiment B1, wherein the determining comprises checking whether a Quality-of-Service Flow Identifier (QFI) associated with the sidelink message matches a QFI that is associated with a first type of sidelink messages and, in response to the QFI matching, selecting the resources from a first set of one or more resource pools allocated for sending the first type of side link messages.
B21. The method according to embodiment B1, wherein the determining comprises checking whether the sidelink message is associated with a particular Logical Channel Identifier (LCH ID) and, in response to the sidelink message being associated with the particular LCH ID, selecting the resources from a first set of one or more resource pools allocated for sending the first type of side link messages.
B22. The method according to any preceding embodiment, wherein the protocol stack is a PC5-U protocol stack.
B23. The method according to any preceding embodiment, wherein the AS layer encompasses, in descending layer order, a Packet Data Convergence Protocol (PDCP) layer, a Radio Link Control (RLC) layer, a Medium Access Control (MAC) layer, and a physical (PHY) layer.
B24. The method according to any preceding embodiment, wherein the method further comprises at a protocol layer above the AS layer, identifying the message type of the sidelink message to be transmitted by the UE, and indicating the message type to the AS layer.
B25. The method according to embodiment B24, wherein the higher layer is an Aircraft-to-Anything (A2X) layer.
B26. The method according to embodiment 24, wherein indicating the message type to the AS layer comprises one of: providing an implicit indication or providing an explicit indication.
B27. The method according to embodiment B26, wherein providing an implicit indication comprises one of: selecting a Quality-of-Service Flow Identifier (QFI) or a Logical Channel Identifier (LCH ID) for the sidelink message in dependence on the message type.
B28. A method of operation by an aerial user equipment (UE), the method comprising mapping one or more types of sidelink messages to one or more specific bearers, for transmission by the UE.
B29. The method according to embodiment B28, wherein the one or more specific bearers are one or more specific Data Radio Bearers (DRBs).
B30. The method according to embodiment B29, wherein the one or more specific DRBs have a one-to-one mapping with one or more respective Logical Channels (LCHs) at a Medium Access Control (MAC) layer of a protocol stack implemented by the UE for sidelink communications.
B31. The method according to embodiment B30, wherein the UE receives configuration information from a wireless communications network, indicating the association of the one or more respective LCHs with the one or more types of sidelink messages, and wherein an Access Stratum (AS) layer of the protocol stack uses the LCH Identifier associated with a given outgoing sidelink message for bearer selection.
B32. The method according to embodiment B31, wherein a higher layer above the AS layer of the protocol stack determines the type of the given outgoing sidelink message and selects and associates a corresponding LCH Identifier with the given outgoing sidelink message, to control the bearer selection by the AS layer.
B33. The method according to any of embodiments B28-B32, wherein the one or more types of sidelink messages include one or both of BRID messages and DAA messages.
B34. The method according to any of embodiments B28-B33, wherein the UE sends BRID and/or DAA messages using a dedicated sidelink configuration and sends other sidelink messages using a common sidelink configuration.
B35. A method of operation by a UE that implements a protocol stack for sidelink communications, the method comprising, with respect to mode-2 resource allocation:
   a lower layer in the protocol stack prioritize resource sensing and selection for a sidelink message to be transmitted, responsive to an indication provided for the sidelink message via a higher layer in the protocol stack.
B36. The method of embodiment 35, wherein the higher layer provides the indication based on determining that the type of the sidelink message is one among one or more prioritized types for which a wireless communication network has allocated a dedicated set of one or more resource pools, and wherein the UE performs the prioritized resource sensing and resource selection with respect to the dedicated set of one or more resource pools.
B37. The method according to embodiment B35 or B36, wherein the higher layer is a Non-Access Stratum (NAS) layer in the protocol stack, and the lower layer is an Access Stratum (AS) layer.
B38. The method according to any of embodiments B35-B37, wherein the resource sensing comprises partial resource sensing.
B39. The method according to any of embodiments B35-B38, wherein the sidelink message is a BRID message or a DAA message.
B40. The method of any of the previous Group I embodiments, further comprising: providing user data; and forwarding the user data to a host via the transmission to the network node.

### Group II Embodiments

B41. A method performed by a network node for configuring resource usage by aerial user equipments (UEs), the method comprising:
   sending configuration information for one or more aerial UEs, indicating a first resource pool to be used for transmitting one or more first types of sidelink messages.
B42. The method according to embodiment B41, wherein the method comprises sending the configuration information by sending Radio Resource Control (RRC) signaling to one or more aerial UEs that are in a RRC Connected mode.
B43. The method according to embodiment B41 or B42, wherein the method comprises sending the configuration information by broadcasting one or more System Information Blocks (SIB) in one or more cells associated with the network node.
B44. The method according to any of embodiments B41-B43, wherein the configuration information indicates a second resource pool to be used for transmitting one or more second types of sidelink messages.
B45. The method according to embodiment B44, wherein the one or more first types of sidelink messages include UAV-type sidelink messages associated with aerial operations, and wherein the one or more second types of sidelink messages include non-UAV type sidelink messages that are not associated with aerial operations.
B46. The method according to embodiment 44, wherein the one or more first types of sidelink messages include UAV-type sidelink messages that are regulatory-related or safety-related, and wherein the one or more second types of sidelink messages include UAV-type messages that are not regulatory-related or safety-related.
B47. The method of any of the previous Group II embodiments, further comprising: obtaining user data; and forwarding the user data to a host or a user equipment.

### Group III Embodiments

B48. A user equipment for aerial operation, comprising:
   processing circuitry configured to perform any of the steps of any of the Group I embodiments; and
   power supply circuitry configured to supply power to the processing circuitry.
B49. A network node for configuring sidelink message with respect to aerial UEs, the network node comprising:
   processing circuitry configured to perform any of the steps of any of the Group II embodiments;
   power supply circuitry configured to supply power to the processing circuitry.
b50. A user equipment (UE) for aerial operation, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group II embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
B51. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
B52. The host of the previous embodiment, wherein:
   the processing circuitry of the host is configured to execute a host application that provides the user data; and
   the UE comprises processing circuitry configured to execute a client application associated with the host application to receive the transmission of user data from the host.
B53. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
BB54. The method of the previous embodiment, further comprising, at the network node, transmitting the user data provided by the host for the UE.
B55. The method of any of the previous 2 embodiments, wherein the user data is provided at the host by executing a host application that interacts with a client application executing on the UE, the client application being associated with the host application.
B56. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
B57. The communication system of the previous embodiment, further comprising:
   the network node; and/or
   the UE.
B58. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
B59. The host of the previous 2 embodiments, wherein:
   the processing circuitry of the host is configured to execute a host application that receives the user data; and
   the host application is configured to interact with a client application executing on the UE, the client application being associated with the host application.
B60. The host of the any of the previous 2 embodiments, wherein the initiating receipt of the user data comprises requesting the user data.
B61. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
B62. The method of the previous embodiment, further comprising at the network node, transmitting the received user data to the host.
B63. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
B64. The host of the previous embodiment, wherein the cellular network further includes a network node configured to communicate with the UE to transmit the user data to the UE from the host.
B65. The host of the previous 2 embodiments, wherein:
   the processing circuitry of the host is configured to execute a host application, thereby providing the user data; and
   the host application is configured to interact with a client application executing on the UE, the client application being associated with the host application.
B66. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
B67. The method of the previous embodiment, further comprising:
   at the host, executing a host application associated with a client application executing on the UE to receive the user data from the host application.
B68. The method of the previous embodiment, further comprising:
   at the host, transmitting input data to the client application executing on the UE, the input data being provided by executing the host application,
   wherein the user data is provided by the client application in response to the input data from the host application.
69. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
B70. The host of the previous embodiment, wherein the cellular network further includes a network node configured to communicate with the UE to transmit the user data from the UE to the host.
B71. The host of the previous 2 embodiments, wherein:
   the processing circuitry of the host is configured to execute a host application, thereby providing the user data; and
   the host application is configured to interact with a client application executing on the UE, the client application being associated with the host application.
B72. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
B73. The method of the previous embodiment, further comprising:
   at the host, executing a host application associated with a client application executing on the UE to receive the user data from the UE.
B74. The method of the previous 2 embodiments, further comprising:
   at the host, transmitting input data to the client application executing on the UE, the input data being provided by executing the host application,
   wherein the user data is provided by the client application in response to the input data from the host application.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

| Abbreviation | Explanation |
|---|---|
| ACK | Acknowledgement |
| AMF | Access and Mobility management Function |
| AN | Access network |
| AS | Access Stratum |
| CE | Control Element |
| CMAS | Commercial Mobile Alert System |
| CN | Core Network |
| CRC | Cyclic Redundancy Check |
| CSS | Cross Slot Scheduling |
| D/A | Detection and avoidance |
| DCI | Downlink control information |
| DL | Downlink |
| DMRS | Demodulation Reference Signal |
| DN | Data Network |
| DRB | Data Radio Bearer |
| DRX | Discontinuous Reception |
| eNB | Base station in LTE |
| ETWS | Earthquake and Tsunami Warning System |
| gNB | Base station in NR |
| HARQ | Hybrid Automatic Request |
| ID | Identifier |
| IP | Internet Protocol |
| L2 | Layer 2 |
| L3 | Layer 3 |
| LTE | Long Term Evolution |
| MAC | Medium Access Control |
| MAC CE | MAC control element |
| MDT | Minimization of Drive Tests |
| MM | Mobility Management |
| NACK | Negative ACK |
| NAS | Non-Access Stratum |
| NDI | New Data Indicator |
| NR | New Radio |
| NW | Network |
| PC5 | A link for sidelink communication |
| PDCCH | Physical Downlink Control Channel |
| PDCP | Packet Data Convergence Protocol |
| PDSCH | Physical Downlink Shared Channel |
| PDU | Protocol Data Unit |
| PEI | Paging Early Indication |
| PF | Paging Frame |
| PO | Paging Occasion |
| ProSe | Proximity-based Services |
| PSBCH | Physical Sidelink Broadcast Channel |
| PSCCH | Physical Sidelink Control Channel |
| PSFCH | Physical Sidelink Feedback Channel |
| PSS | Primary Synchronization Signal |
| PSSCH | Physical Sidelink Shared Channel |
| RAN | Radio Access Network |
| RB | Radio Bearer |
| RLC | Radio Link Control |
| RNTI | Radio Network Temporary Identifier |
| RSRP | Reference Signal Received Power |
| RSRQ | Reference Signal Received Quality |
| RSSI | Received Signal Strength Indicator |
| RS-SINR | Reference signal SINR |
| RRC | Radio Resource Control |
| RV | Redundancy Version |
| RX | Receive |
| SCI | Sidelink Control Information |
| SIB | System Information Block |
| SINR | Signal-to-Interference-plus-Noise Ratio |
| SL | Sidelink |
| SL-RNTI | Sidelink-RNTI |
| SM | Session Management |
| SON | Self-organizing network |
| SPS | Semi-persistent scheduling |
| SRB | Signaling Radio Bearer |
| S-PSS | Sidelink-PSS |
| SSS | Secondary Synchronization Signal |
| S-SSS | Sidelink-SSS |
| SSID | Sidelink Synchronization identity |
| TAI | Tracking Area Identity |
| TB | Transport Block |
| TR | Technical Report |
| TX | Transmit |
| UAS | Unmanned aerial system/Unmanned aircraft system |
| UAV | Unmanned aerial vehicle |
| UC | Use case |
| UCI | Uplink Control Information |
| UE | User Equipment (Wireless device in 3GPP systems) |
| UL | Uplink |
| V2V | Vehicle-to-vehicle communication |
| V2X | Vehicle-to-anything communication |
| WG | Working Group |
| WUS | Wake-Up Signal |

1. A method, in a wireless device in, on, or forming part of an unmanned aerial vehicle, UAV, the method comprising:
determining resources for a sidelink transmission of a message by the wireless device, wherein said determining is based on whether the transmission comprises Unmanned aerial vehicle, UAV, related information; and
transmitting the message, using the determined resources.

2. The method of claim 1, wherein the method further comprises determining to transmit UAV identifier, ID, information and wherein said determining resources for the sidelink transmission of the message comprises determining one or more resources that are specifically designated for use in transmitting UAV ID information.

3. The method of claim 1, wherein the method further comprises determining to transmit UAV detection and avoidance, DAA, information, and wherein said determining resources for the sidelink transmission of the message comprises determining one or more resources that are specifically designated for use in transmitting UAV-related information.

4. The method of claim 3, wherein the determined one or more resources are specifically designated for use in transmitting UAV ID information, to the exclusion of transmitting non-UAV-related information.

5. The method of claim 1, wherein determining the resources for the sidelink transmission of the message comprises selecting one or more resources from a plurality of resources specifically designated for use in transmitting UAV-related information.

6. The method of claim 5, wherein the plurality of resources is predetermined by any one of more of:
hard coding;
network configuration; and
pre-configuration information stored in a SIM or USIM.

7. The method of claim 6, wherein the plurality of resources is one of multiple sets of resources available to the wireless device for use in transmitting information.

8. The method of claim 7, wherein the one of the multiple sets of resources is selected using information received by the wireless device from a wireless network, indicating that the one is specifically designated for use in transmitting UAV identifier, ID, information being received via Radio Resource Control, RRC, signaling or via a System Information Block, SIB, broadcasted by the wireless network.

9. The method of claim 1, wherein said determining resources for the sidelink transmission of the message comprises:
interpreting an implicit or explicit indication associated with the message, the implicit or explicit indication indicating a message type of the sidelink message; and
selecting resources for transmission of the sidelink message, based on the message type.

10. The method of claim 9, wherein the indication further indicates that the message comprises at least one of:
UAV identifier, ID, information; and
UAV detection and avoidance, DAA, information.

11. The method of claim 9, further comprising:
controlling the indication in a higher layer of a protocol stack implemented in the wireless device, the higher layer being above the access stratum layers of the protocol stack; and
sending the indication to the access stratum layers of the protocol stack, wherein the interpreting of the indication is performed in at least one of the access stratum layers of the protocol stack.

12. The method of claim 11, wherein the interpreting of the indication is performed in a medium access control, MAC, layer of the protocol stack, the access stratum layers comprising the MAC layer.

13. The method of claim 9, wherein determining the resources further comprises:
checking whether a Quality-of-Service Flow Identifier, QFI, associated with the sidelink message matches a QFI that is associated with at least one of:
messages carrying UAV ID information; and
messages carrying UAV DAA information.

14. The method of claim 9, wherein determining the resources further comprises:
checking whether the sidelink message is associated with a particular Logical Channel Identifier, LCH ID; and
selecting, in response to the sidelink message being associated with the particular LCH ID, the resources from a first set of one or more resource pools allocated for sending a type of sidelink message associated with the particular LCH ID.

15. The method of claim 9, further comprising:
mapping the message type of the sidelink message to a specific bearer for transmission by the wireless device, wherein the specific bearer is a specific Data Radio Bearer, DRB.

16. (canceled)

17. The method of claim 15, wherein the specific DRB is one of one or more specific DRBs having a one-to-one mapping with one or more respective Logical Channels, LCHs, at a Medium Access Control, MAC, layer of a protocol stack implemented by the wireless device for sidelink communications.

18. The method of claim 17, further comprising:
receiving configuration information from a wireless communications network, the configuration information indicating the association of the one or more respective LCHs with the one or more types of sidelink messages, and wherein an Access Stratum, AS, layer of the protocol stack uses an LCH Identifier associated with a given outgoing sidelink message for selection by the specific bearer.

19. The method of claim 11, wherein said selecting resources for transmission of the sidelink message, based on the message type, comprises selecting a HARQ-less resource pool for transmission of the sidelink message.

20. A method, in a network node of a wireless network, the method comprising:
sending, to at least one wireless device in, on, or forming part of an unmanned aerial vehicle, UAV, configuration information indicating a designation of one or more resources as being specifically for use in transmitting at least one of:
UAV ID information; and
UAV detection and avoidance information.

21-28. (canceled)

29. A wireless device, comprising:
communications circuitry; and
processing circuitry operatively coupled to the communication circuitry and configured to, with the communication circuitry:
determine resources for a sidelink transmission of a message by the wireless device, wherein said determining is based on whether the transmission comprises Unmanned aerial vehicle, UAV, related information, and
transmit the message, using the determined resources.

30-33. (canceled)
